(19) United States
(12) Patent Application Publication
(10) Pub. No.: US 2025/0292283 A1
(43) Pub. Date: Sep. 18, 2025

(54) Device And Method For Assisting Sponsorship Of Sports Team, And Program Therefor

(71) Applicant: ENGATE, INC., Chuo-ku Tokyo (JP)

(72) Inventors: Koichiro KIDO, Chuo-ku Tokyo (JP); Kurando MINAMI, Chuo-ku Tokyo (JP); Kenshiro TAMURA, Chuo-ku Tokyo (JP)

(73) Assignee: ENGATE, INC., Chuo-ku Tokyo (JP)

(21) Appl. No.: 19/224,231

(22) Filed: May 30, 2025

Related U.S. Application Data
(63) Continuation of application No. PCT/JP2023/043387, filed on Dec. 5, 2023.

(30) Foreign Application Priority Data
Dec. 6, 2022 (JP) 2022-194552
Feb. 17, 2023 (JP) 2023-023362

(51) Int. Cl. G06Q 30/0226

(52) U.S. Cl. CPC G06Q 30/0233

(57) ABSTRACT

This invention provides a new method of allowing sports sponsorship that does not require the installation of physical advertising materials to gain exposure during a game. First, the apparatus 110 grants a quantity of points to the fan in response to an action by the fan (S201). The actions to which points are granted are those designated by the sponsor company using the company terminal 120. At least part of the source of the points granted to the fan is borne by the sponsor company. Next, the apparatus 110 receives a request from the fan terminal 140 for a possible digital gift using the points granted (S202). The points shall be usable for a digital gift to a given sports team. The apparatus 110 then adds the number of points earned in accordance with the number of points for the digital gift included in the gift request to the points earned by the sports team to which the gift is to be given (S203).

### RELATED APPLICATIONS

This is a continuation of Application International PCT/JP2023/043387 filed on Dec. 5, 2023. This application claims the priority of Japanese application no. JP 2022-194552 filed Dec. 6, 2022, and Japanese application no. JP 2023-023362 filed Feb. 17, 2023, the entire content of which is hereby incorporated by reference.

### FIELD OF THE INVENTION

This invention relates to an apparatus, method, and program for supporting sponsorships for sports teams.

### BACKGROUND ART

In addition to admission fees for games played in stadiums, sports teams' main sources of revenue are advertising revenues from sponsors, media rights revenues for broadcasting or distributing games, and revenues from the sale of merchandise related to the team or its players. The revenue generated in this way is used for player compensation, player development, etc.

Of the above revenue sources, advertising revenue is mainly obtained from uniform advertising, in which the sponsor company displays its logo on the uniform, and from billboard advertising, in which the sponsor company places billboards in the stadium where the game is played and displays its logo on the billboards. The exposure to a large number of spectators and viewers is obtained by these advertisements being seen by spectators during the game and also by these advertisements being shown on TV, thereby enhancing the brand value of the company or its products.

### SUMMARY OF THE INVENTION

Sports sponsorship is a powerful advertising method that takes advantage of the characteristics of sports to attract the attention of a wide range of fans, transcending differences in generation, gender, language, religion, etc., and to create a positive impression of support for the sport. On the other hand, it also involves the installation of physical advertising materials, so advertising space is limited and tends to be expensive. For example, uniform advertising at European soccer clubs can cost as much as 30 million pounds per year for a five-year contract. In addition, the cost of various activities called “activation,” which are carried out to ensure that the rights acquired through sponsorship contracts are used effectively, is unavoidable.

The present invention was made in view of the above, and its objective is to provide an apparatus, method or program for enabling new sports sponsorships that do not require the installation of physical advertising materials to gain exposure during games.

### Solution to the Problem

To achieve the objective, a first aspect of the invention is a method for supporting sponsorship of a sports team, comprising steps of: granting a quantity of points corresponding to an action of a user to the user, the action being an action specified by a sponsor company of the sports team; receiving a request for sending a digital gift to the sports team using the points from a user terminal used by the user; and adding acquired points corresponding to points of the digital gift to balance points of the sports team, which is a recipient of the digital gift; wherein the points are a portion of points set to the sponsor company as grantable points corresponding to consideration borne by the sponsor company; and wherein the points only usable for digital gifts to the sports team or a predetermined plurality of teams.

The second aspect of the invention is the method of the first aspect, wherein the action is an action performed on the Internet.

The third aspect of the invention is the method of the second aspect, wherein the action is an action performed on a website provided by the sponsoring company.

The fourth aspect of the invention is the method of the first aspect, wherein the action is an action performed in the store of the sponsoring company.

The fifth aspect of the invention is the method of the third aspect, wherein the action is an operation of bringing the user terminal into proximity with an NFC component included in a store-installed object installed at the store.

The sixth aspect of the invention is the method of any of the first through fifth aspects, wherein the action is an action set by the sponsoring company that has received prior approval from the sports team.

The seventh aspect of the invention is the method of any of the first through fifth aspects, wherein the action is an action that has received prior approval from the sports team.

The eighth aspect of the invention is the method of any of the first through the fourth aspects, wherein the action is payment for goods sold by the sponsoring company or services provided by the sponsoring company.

The ninth aspect of the invention is the method of any of the first through fourth aspects, wherein the action is the input of answers to one or more questions set by the sponsoring company.

The tenth aspect of the invention is the method of any of the first through the ninth aspects, wherein the gift request using the points is possible only within a same season in which the points were granted.

An eleventh aspect of the invention is a program for causing a computer to execute a method for supporting sponsorship of a sports team, the method comprising steps of: granting a quantity of points corresponding to an action of a user to the user, the action being an action specified by a sponsor company of the sports team; receiving a request for sending a digital gift to the sports team using the points from a user terminal used by the user; and adding acquired points corresponding to points of the digital gift to balance points of the sports team, which is a recipient of the digital gift; wherein the points are a portion of points set to the sponsor company as grantable points corresponding to consideration borne by the sponsor company; and wherein the points only usable for digital gifts to the sports team or a predetermined plurality of teams.

The twelfth aspect of the invention is an apparatus for supporting sponsorship of a sports team, configured to: grant a quantity of points corresponding to an action of a user to the user, the action being an action specified by a sponsor company of the sports team; receive a request for sending a digital gift to the sports team using the points from a user terminal used by the user to add acquired points corresponding to points of the digital gift to balance points of the sports team, which is a recipient of the digital gift; wherein the points are a portion of points set to the sponsor company as grantable points corresponding to consideration borne by the sponsor company, and wherein the points only usable for digital gifts to the sports team or a predetermined plurality of teams.

According to an aspect of the present invention, a user who performs an action specified by a sponsoring company is granted points for which the sponsoring company has borne consideration, and the points can be used for a digital gift to a sports team or a predetermined number of sports teams that are the target of the sponsorship by the sponsoring company. By this arrangement, a new type of sports team sponsorship is possible that does not necessarily require physical advertising materials for the sponsoring company to gain exposure during the game.

### BRIEF DESCRIPTION OF THE DRAWINGS

FIG. 1 shows a system for one embodiment according to the present invention.

FIG. 2 shows a flow chart of the method according to one embodiment of the present invention.

FIG. 3 shows an example of the product purchase screen according to one embodiment of the present invention.

FIG. 4 shows an example of a store-installed object according to one embodiment of the present invention.

FIG. 5 shows a flow chart of point allocation using a store-installed object according to one embodiment of the present invention.

### DETAILED DESCRIPTION OF THE EMBODIMENTS

The following is a detailed description of the embodiments according to the present invention with reference to the drawings.

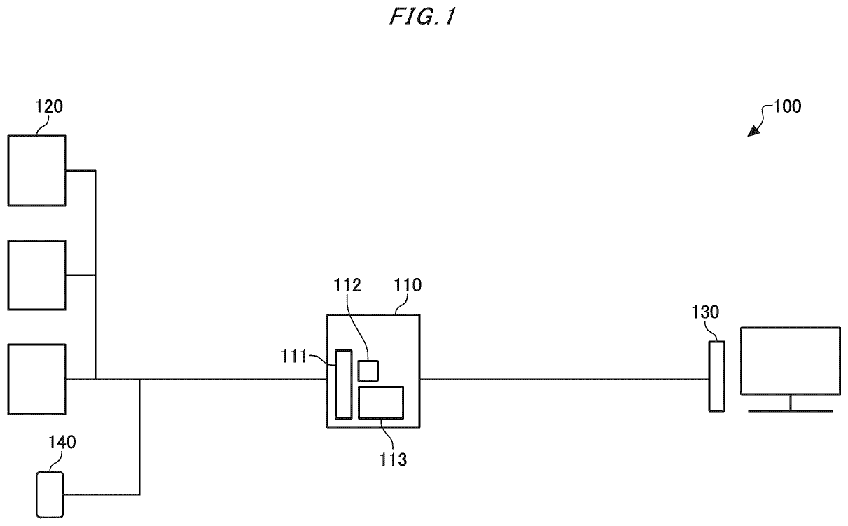

FIG. 1 shows a system for an embodiment according to the present invention. The system 100 comprises an apparatus 110 for supporting sponsorship of a sports team, a company terminal 120 used by a sponsor company of the sports team, a team terminal 130 used by the sports team, and a fan terminal 140 used by a fan of the sports team. Although multiple company terminals are shown in FIG. 1 because there can be multiple sponsor companies, we will focus on one of them. Conversely, only a single terminal is shown for the fan terminal 140, but there can be more than one. The apparatus 110 communicates with the company terminal 120, the team terminal 130, and the fan terminal 140 via an IP network such as the Internet.

The apparatus 110 comprises a communication unit 111 such as a communication interface, a processing unit 112 such as a processor, a CPU, etc., and a storage unit 113 including a storage apparatus or a storage medium such as a memory, a hard disk, etc., and can be configured by executing a program for performing each process or operation by the processing unit 112. The apparatus 110 may include one or more apparatuses, computers or servers, and the program may include one or more programs, and may be stored on a computer-readable storage medium to form a non-transitory program product. The program may be stored in a storage unit 113 or in a storage apparatus or a storage medium such as a database accessible from the apparatus 110 via an IP network, and may be executed by the processing unit 112. The data described below as being stored in the storage unit 113 may be stored in a storage apparatus or a storage medium such as the database and vice versa.

First, the apparatus 110 grants a number of points to the fan corresponding to an action taken by the fan using the fan terminal 140 (S201). For example, the action to be subject to point allocation is an action specified by the sponsor company using the company terminal 120, and can be, for example, an action entered by the sponsor company into an action setting input screen provided by the apparatus 110 using the corporate terminal 120 and stored in the storage unit 113. A business operator operating the sponsorship support service provided by the apparatus 110 may enter the action specified by the sponsor company to the apparatus 110, which may be stored in the memory unit 113.

Input by the sponsor company can be for example performed from the input screen displayed on the display screen of the company terminal 120 in a web browser by sending the input screen display information as an HTML format file, or by running an application installed on the company terminal 120 (hereinafter also referred to as “app”) and performing the input from the input screen displayed on the app. The “input screen” is an input screen that is displayed on the web browser on the display screen of the company terminal 120. The “input screen” can take various forms, such as a web page, modal window, or pop-up window when displayed on a web browser, or a screen of the application when displayed on the application. In any of these cases, any screen that includes an area with an input field for entering setting information falls under the category of a setting information input screen. The same techniques can be applied to other screens referred to herein.

Examples of actions include product purchases, survey responses, card applications, and video viewing. In addition, the number of points to be granted for the action may be specified or entered in association with the action. A product purchase can more specifically be a payment for a product sold by a sponsor company, or in the case of a service rather than a product, a payment for a service provided by a sponsor company may be specified as an action. The survey response can more specifically be the input of answers to one or more questions set by the sponsor company. In addition, if the action is an action that takes place on the Internet, the sports sponsorship is freed from physical constraints. Video viewing can be the viewing of a video specified by the sponsor company on the Internet, or more specifically, the start of viewing of a video specified by the sponsor company. As an example, the start of viewing can be detected based on the fan's selection of the video by clicking or tapping the play button of the video. Completion of viewing of the video can be detected in addition to the start of viewing, and the start and completion of viewing can be defined as the action. Video viewing can be performed, for example, on a screen provided by the apparatus 110. Alternatively, the action may be a purchase of a product at the sponsor company's store.

As described below, the sponsor company bears at least part of the source of the points granted to fans, which is, so to speak, an advertising expense for the sponsor company concerned. By granting points to fans who perform the actions specified by the sponsor company as described above, the number of actions or corresponding numbers can be quantitatively measured as advertising effects, making the ROI of sports sponsorships transparent.

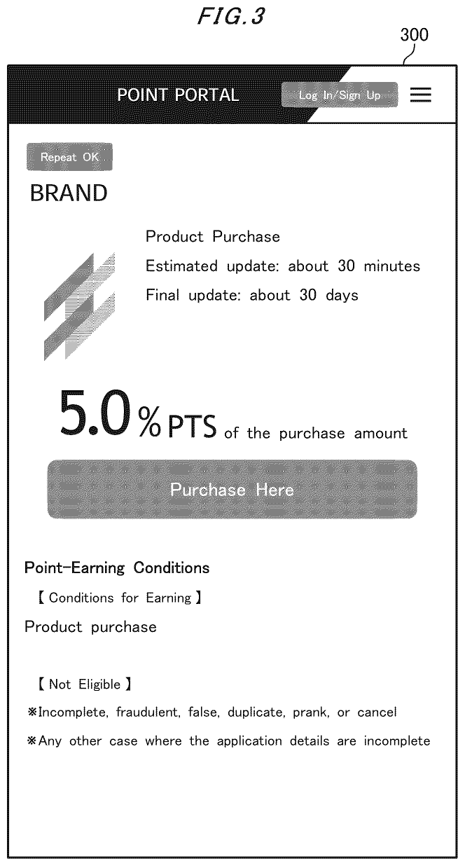

FIG. 3 shows an example of a product purchase screen according to an embodiment of the present invention. The product purchase screen 300 is provided by the apparatus 110 for a fan to perform the action of purchasing a product. When a product purchase is made, points equivalent to 5% of the amount paid are granted to the fan and stored in the storage unit 113 in association with a fan identifier that identifies the fan.

In this example, the fan performs the purchase of the product on the screen provided by the apparatus 110, but it may be possible to cause transition from the screen provided by the apparatus 110 to a website where the purchase of the product or other action can be performed. The website may be more specifically a website provided by the sponsor company that specified the action in question. In this case, the operator of the sponsorship support service provided by the apparatus 110 receives from the sponsor company a notification of the action taken, or the number of points to be granted in response thereto or a symbol such as a coupon code representing the same, together with a fan identifier identifying the fan, and store them in the memory unit 113. When an action is performed at a sponsor company's store, it may be sufficient for the operator of the sponsorship support service provided by the apparatus 110 to receive a notification from the sponsor company of the action performed, or the number of points to be granted accordingly or a symbol representing the same, together with a fan identifier identifying the fan.

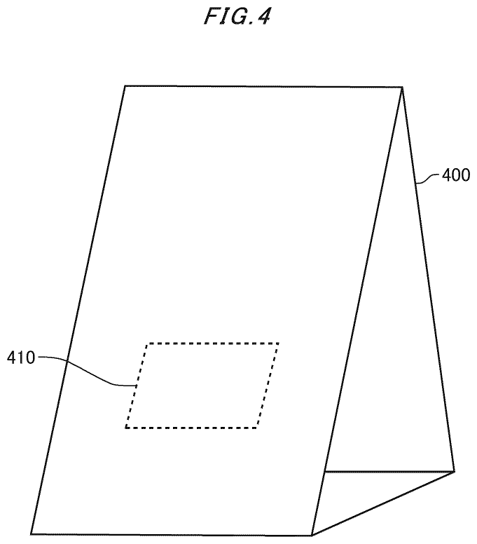

An example of the action performed at the sponsor company's store (also referred to as “storefront actions” below) is an action in which a fan terminal 140 is brought into proximity with an NFC component included in the store-installed object installed at a store. FIG. 4 shows an example of a storefront installation. The storefront installation 400 has an NFC component 410 that can communicate with NFC tags, NFC cards, and other NFC standards. For example, the NFC component 410 may be affixed to the storefront installation 400 that can be placed on a tabletop. In the example in FIG. 4, it is affixed to the inside of the storefront installation 400.

When a fan brings the fan terminal 140 into proximity to the NFC component 410 included in the store-installed object and the URL registered in the NFC component 410 is read (S501), the web browser operating on the fan terminal 140 sends a request to the URL (S502). The URL is a location on the apparatus 110, and can be determined to be different for each sponsor company or for each sponsor company's store, and registered in the NFC component 410. The apparatus 110 checks whether or not the requested URL or part thereof has been set as a target for point allocation in advance (S503), and if the check result is affirmative, the predetermined points are associated with a fan identifier, that identifies the fan using the fan terminal 140 that sent the request, and are stored in the storage unit 103 (S504). Here, if necessary, the fan may be authenticated and the predetermined point may be granted after authentication. The number of points and the period of time for which points are granted may be set in the apparatus 110 in association with the URL or a portion thereof, and the number of times the same fan can receive a point grant may also be set. In addition, the apparatus 110 can be set with a URL of a transition destination to be displayed on the web browser of the fan terminal 140 in association with the URL or part thereof. When the URL of a transition destination is set, the apparatus 110 transmits to the fan terminal 140 display information for displaying the web page specified by the transition destination URL (S505). It is preferable for the apparatus 110 to delete the URL read from the NFC component 410 from the history of the web browser operating on the fan terminal 140 at the time of, or before or after, sending the display information to the fan terminal 140.

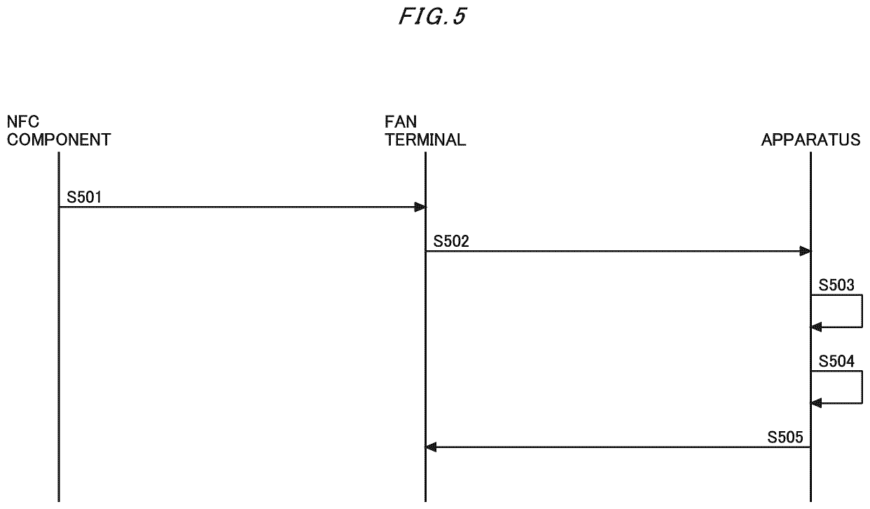

In the explanation of FIG. 5, we focused on one sponsor company. When there are first and second sponsor companies for the same sports team, and a fan performs a storefront action at a second store, more points may be granted compared to when the fan initially visits the store. More generally, when there are multiple sponsor companies for the same sports team, the points granted for the latest storefront action may be increased according to the number of stores where the storefront action was performed.

Next, the apparatus 110 receives from the fan terminal 140 a request for a gift of a digital gift (S202), which can be made using points granted in response to the above action. The gift request includes the digital gift to be given and the sports team or its players to whom the gift is to be given. The apparatus 110 may provide the fan with a gift request input screen for giving a digital gift, and may also provide a digital gift display screen viewable by the fan and the sports team or its players. By displaying who gave which gift to whom on the digital gift display screen, fans can communicate their feelings about the game by giving gifts during the game, and they can communicate their expectations, support, etc. for the team or its players by giving gifts before and after the game.

Upon receipt of the gift request, the apparatus 110 determines, if necessary, whether the points required for the gift identified by the digital gift included in the gift request are less than or equal to the points granted to the fan identified by the fan identifier. The apparatus 110 may only allow the gift request to be made within the same season as the season in which the points used in the gift request were granted to the fan.

It is preferable that the points granted in response to the action can be used for digital gifts to a given sports team or its players. By restricting the use of points in this manner, the sponsor company that specifies the action can gain exposure to the fans of the predetermined sports team as a company that supports the predetermined sports team, and can obtain advertising effects to desired consumer base. It is preferred that the predetermined sports team be a single sports team, but it is also conceivable that it could be multiple sports teams.

This effect is further enhanced by making the points awarded in response to the action in question unavailable for use as digital gifts to sports teams or players other than the designated sports team or its players. Since such an action leads to an increase in digital gifts to the sports team to which the points can be used, for example, it provides an incentive for the sports team to use its own SNS account to announce the action. The restrictive conditions for such points can be stored in the storage unit 113, and the apparatus 110 that receives the gift request can determine whether such conditions are met, if necessary.

The actions for which points are granted can be either actions set by the sponsoring company with prior approval from the sports team to which the granted points can be used or actions approved by the sports team to which the granted points can be used. Requiring the approval of the sponsor team provides a stronger incentive for the sports team to notify fans of the action in question. If the action itself is subject to approval, the sports team can specifically confirm in advance that the action in question is not likely to damage the brand of the sports team.

The apparatus 110 then adds the quantity of points earned according to the number of points for the digital gift included in the gift request to the points earned by the sports team to which the digital gift was given (S203). The apparatus 110 may provide a management screen on which the team terminal 130 can check the earned points.

The points granted to fans for performing the specified action shall be paid at least a portion of their consideration as advertising expenses by the sponsor company that specified the action. To illustrate the flow of advertising fees from a sponsor company to a sports team, when a sponsor company provides a sponsorship of 10 million yen, the sponsor company pays a business operator of the sponsorship support service provided by the apparatus 110. The operator sets a quantity of points, e.g., 9 million points, as points that can be granted to the sponsor company in proportion to the amount paid minus a certain fee, e.g., 9 million yen, and stores the points in the storage unit 113 in association with a company identifier that identifies the sponsor company. If a fan is granted points, e.g., 100 points, in response to the fan performing an action designated by the sponsoring company, those points are part of the grantable points, and the apparatus 110 updates the balance of the grantable points or adds the points already granted. If a fan who has been granted points through multiple actions gives a digital gift to a sports team to which the accumulated points can be used, the apparatus 110 updates the points earned by the sports team by adding the necessary points for the digital gift, e.g., 500 points. The sports team in question may receive a payment in an amount corresponding to the points earned from the entity operating the sponsorship support service provided by the apparatus 110.

In this way, in the present embodiment, users who perform actions designated by the sponsor company are given points for which the sponsor company has paid compensation, and the points can be used for digital gifts to the sports team that is the target of the sponsorship by the sponsor company. This new type of sports team sponsorship does not necessarily require physical advertising materials to gain exposure during the game. This new type of sponsorship provides new advertising opportunities that can be quantitatively analyzed for effectiveness, as the actions taken by fans can be visualized as an advertising effects.

In the above embodiments, it is to be noted that if the term “only” is not written, such as in “based only on”, “only in response to”, or “only in the case of x”, in the present Specification, it is assumed that additional information may also be taken into account. Also, as an example, it is to be noted that a description “b is performed in the case of a” does not necessarily mean “b is always performed in the case of a” or “a is performed immediately after a” except where expressly stated. Also, a description “each a which is part of A” does not necessarily mean that A comprises a plurality of elements and it includes a case where A is composed of a single element.

In addition, as a caveat, even if there are aspects of a method, a program, a terminal, an apparatus, a server or a system (hereinafter referred to as “method, etc.”) that perform operations different from those described herein, each aspect of the invention is intended to perform the same operation as one of the operations described herein, and the existence of an operation different from those described herein does not mean that the method, etc. is outside the scope of each aspect of the invention.

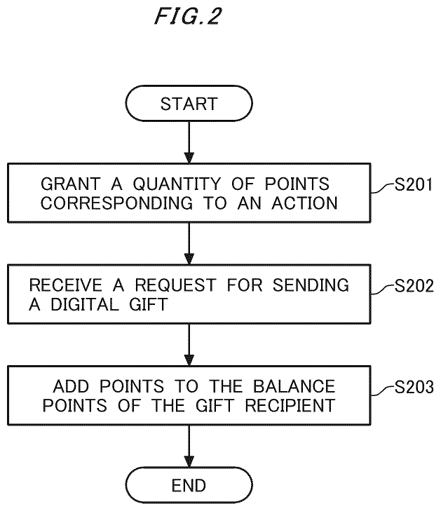

The “START” and “END” shown in FIG. 2 are only exemplary, and do not imply that the method of the present embodiment always starts with the illustrated procedure and always ends with the illustrated procedure.

### REFERENCE SIGNS LIST

100 System
110 Apparatus
111 Communication unit
112 Processing unit
113 Storage unit
120 Company terminal
130 Team terminal
140 Fan terminal
300 Product purchase screen
400 Store-installed object
410 NFC Component

1. A method for supporting sponsorship of a sports team, comprising steps of:
granting a quantity of points corresponding to an action of a user to the user, the action being an action specified by a sponsor company of the sports team;
receiving a request for sending a digital gift to the sports team using the points from a user terminal used by the user; and
adding acquired points corresponding to points of the digital gift to balance points of the sports team, which is a recipient of the digital gift;
wherein the points are a portion of points set to the sponsor company as grantable points corresponding to consideration borne by the sponsor company; and
wherein the points only usable for digital gifts to the sports team or a predetermined plurality of teams.

2. The method according to claim 1, wherein the action is an action performed on the Internet.

3. The method according to claim 1, wherein the action is an action performed at s store of the sponsor company.

4. The method according to claim 3, wherein the action is an operation of bringing the user terminal into proximity with an NFC component included in a store-installed object installed at the store.

5. The method according to claim 1, wherein the action is an action that has been pre-approved by the sports team.

6. The method according to claim 1, wherein the action is payment for a product sold by the sponsor company or for a service provided by the sponsor company.

7. The method according to claim 1, wherein the action is input of an answer to one or more questions set by the sponsor company.

8. The method according to claim 1, wherein the request using the points is possible only within a same season in which the points were granted.

9. A program for causing a computer to execute a method for supporting sponsorship of a sports team, the method comprising steps of:
granting a quantity of points corresponding to an action of a user to the user, the action being an action specified by a sponsor company of the sports team;
receiving a request for sending a digital gift to the sports team using the points from a user terminal used by the user; and
adding acquired points corresponding to points of the digital gift to balance points of the sports team, which is a recipient of the digital gift;
wherein the points are a portion of points set to the sponsor company as grantable points corresponding to consideration borne by the sponsor company; and
wherein the points only usable for digital gifts to the sports team or a predetermined plurality of teams.

10. An apparatus for supporting sponsorship of a sports team, configured to:
grant a quantity of points corresponding to an action of a user to the user, the action being an action specified by a sponsor company of the sports team;
receive a request for sending a digital gift to the sports team using the points from a user terminal used by the user to add acquired points corresponding to points of the digital gift to balance points of the sports team, which is a recipient of the digital gift;
wherein the points are a portion of points set to the sponsor company as grantable points corresponding to consideration borne by the sponsor company, and
wherein the points only usable for digital gifts to the sports team or a predetermined plurality of teams.
